(19) United States
(12) Patent Application Publication
(10) Pub. No.: US 2012/0313902 A1
(43) Pub. Date: Dec. 13, 2012

(54) CAPACITIVE TOUCH STRUCTURE

(76) Inventor: MAO-SUNG WU, Taoyuan City (TW)

(21) Appl. No.: 13/398,135

(22) Filed: Feb. 16, 2012

Related U.S. Application Data
(63) Continuation-in-part of application No. 13/157,389, filed on Jun. 10, 2011.

(30) Foreign Application Priority Data
Nov. 23, 2011 (TW) 100222203

(51) Int. Cl. G06F 3/033

(52) U.S. Cl. 345/179

(57) ABSTRACT

A capacitive touch structure comprises a transparent hand holding portion and a touch portion, and the transparent hand holding portion includes a rod and a transparent conductive film covered onto an external surface of the rod, and the touch portion is disposed at an end of the transparent hand. holding portion and includes a flexible conductive element electrically coupled to the transparent conductive film, such that a user can hold the hand holding portion, and the flexible conductive element can be contacted with the capacitive touch panel to produce a capacitive coupling and generate a current to achieve the effect of a touch operation.

### CROSS-REFERENCE TO RELATED APPLICATIONS

This application is a continuation-in-part of U.S. Ser. No. 13/157,389 filed on Jun. 10. 2011, and claims priority to Taiwanese Patent Application No. 100222203, filed on Nov. 23, 2011, the entire contents and disclosure of which are hereby incorporated by reference.

### BACKGROUND OF THE INVENTION

(a) Field of the Invention

The present invention relates to a capacitive touch structure, in particular the capacitive touch structure capable of transmitting a current to a human body through a touch element to achieve the effect of a touch operation.

(b) Description of the Related Art

At present, touch technology is used extensively in various different electronic products. For example, a resistive touch panel is pressed to contact upper and lower conductive films with one another to control the resistive touch panel; and a capacitive touch panel is touched gently by a finger to produce a change of capacitance between the finger and the capacitive touch panel to control the capacitive touch panel. Obviously, the sensitivity of the capacitive touch panel is much higher and more advantageous than the sensitivity of the resistive touch panel in their operation.

In addition, the capacitive touch panel has the following advantages over a general resistive touch panel, and these advantages include the features of dustproof, fire-resistance, scratch-resistance, high resolution, high transmittance, low reflection, high contrast, and excellent durability as well as supporting several touch points and operating gestures, so that the capacitive touch panel has become one of the manufacturers' developing targets.

With reference to FIG. 1, a user of a capacitive touch panel 91 controls and operates a virtual keyboard 93 of the capacitive touch panel 91 by a finger 92. However, the finger 92 blocks a portion of the user's vision in the operating process, and the finger 92 with a relatively large area may touch other areas easily to cause an expected action or mis-touches occur frequently. The problem of mis-touches becomes more serious for users with a big finger.

In addition, a nail 94 of the finger 92 is not a conductor, so that an appropriate capacitance for controlling and operating the capacitive touch panel 91 cannot be produced between the nail 94 and the capacitive touch panel 91. As a result, users with long nails may have difficulties to operate the capacitive touch panel 91.

In addition, the finger may be stained easily, particularly in hot weather, the issue of having sweat on the hands is inevitable, so that sweats and stains usually remain on the capacitive touch panel 91 after the capacitive touch panel 91 is touched by the finger 92 frequently, and it is difficult to maintain the capacitive touch panel 91 clean.

At present, the technology of using the finger 92 to control and operate the capacitive touch panel 91 still has problems that require breakthroughs. Thus, it is a main subject for related manufacturers to produce an appropriate capacitance to operate and control the capacitive touch panel 91 while maintaining a clean capacitive touch panel 91; or develop a touch structure that can be applied in various different touch panels and attached closely with the touch panel to prevent the touch panel from being damaged.

### SUMMARY OF THE INVENTION

Therefore, it is a primary objective of the present invention to overcome the drawbacks of the prior art by providing a capacitive touch structure that can transmit a current to a human body by a touch element to achieve the effect of a touch operation.

To achieve the aforementioned objective, the present invention provides a capacitive touch structure comprising a transparent hand holding portion and a touch portion, wherein the transparent hand holding portion includes a rod and a transparent conductive film covered onto an external surface of the rod, and the touch portion is disposed at an end of the transparent hand holding portion and has a flexible conductive element electrically coupled to the transparent conductive film, and a user can hold the hand holding portion. When the flexible conductive element is contacted with the capacitive touch panel to produce a capacitive coupling to generate a current, the effect of a touch operation is achieved.

### BRIEF DESCRIPTION OF THE DRAWINGS

FIG. 1 is a schematic view of using a conventional touch panel;

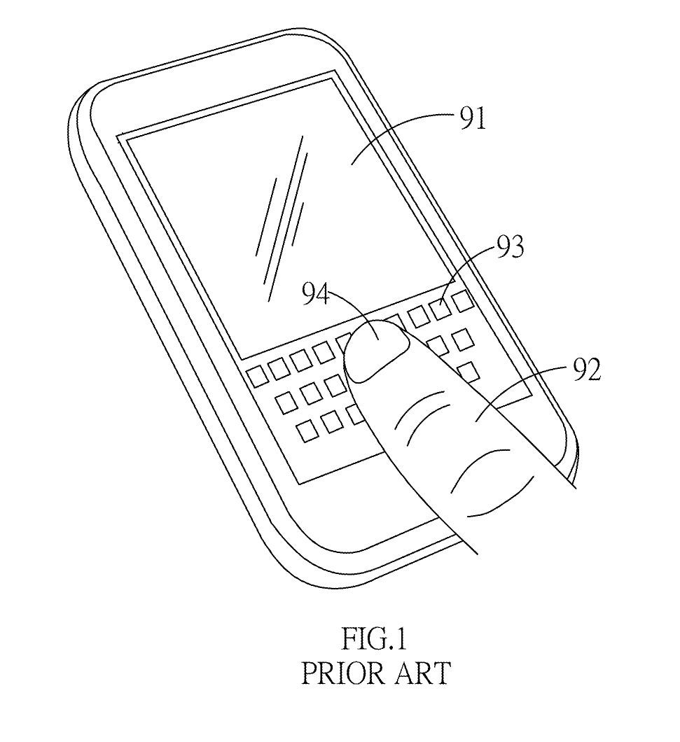

FIG. 2 is a perspective view of a capacitive touch structure of the present invention;

FIG. 3 is an exploded view of a capacitive touch structure of the present invention;

FIG. 4 is a schematic view of a capacitive touch structure of the present invention; and

FIG. 5 is another schematic view of a capacitive touch structure of the present invention.

### DETAILED DESCRIPTION OF THE PREFERRED EMBODIMENTS

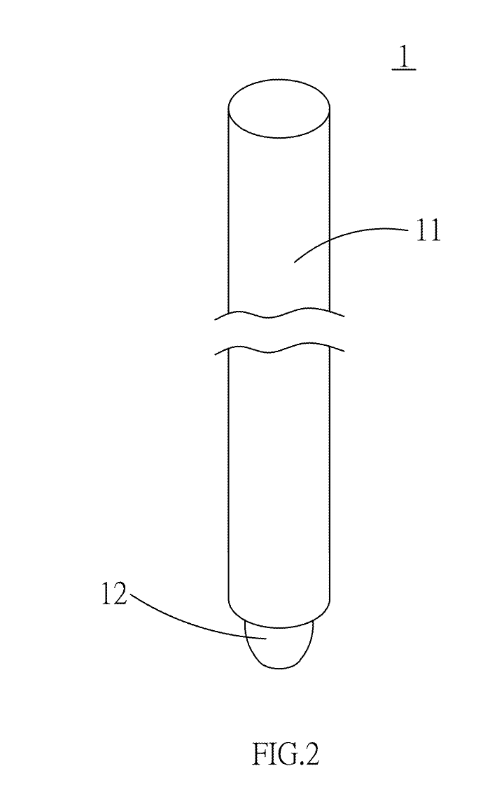

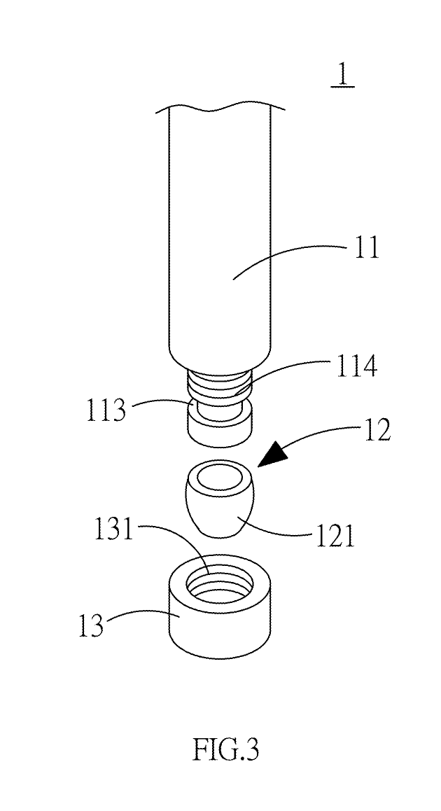

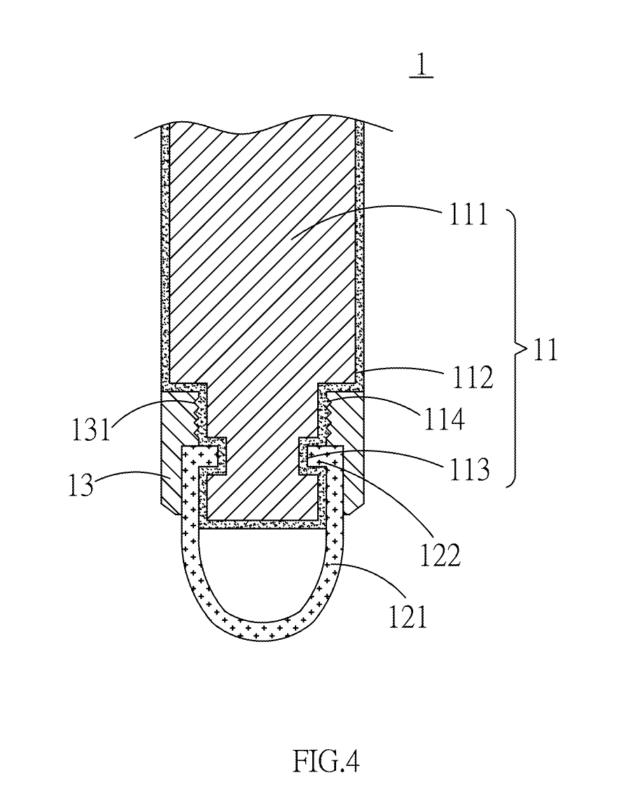

With reference to FIGS. 2 to 4 for the basic structure of a capacitive touch in accordance with the present invention, the capacitive touch structure 1 comprises a transparent hand holding portion 11 and a touch portion 12.

The transparent hand holding portion 11 is provided for a user to hold, and the transparent hand holding portion 11 of this preferred embodiment includes a rod 111 and a transparent conductive film 112 covered onto an external surface of the rod 111, wherein the rod 111 is made of an acrylic, crystal, glass, transparent plastic, PC, PS, PVC or ABS material, and the transparent conductive film 112 is made of a conductive polymer material.

The transparent hand holding portion 11 is manufactured by different methods as described below:

1. The rod is dipped into a liquid conductive polymer material for approximately 3 seconds and then baked at 80˜85° C. for approximately 20 seconds until the transparent conductive film with the conductive polymer material is uniformly attached onto the external surface of the rod.

2. The rod is dipped into a liquid conductive polymer material for approximately 3 seconds and then baked at 50˜60° C. for approximately one minute until the transparent conductive film with the conductive polymer material is uniformly attached onto the external surface of the rod.

3. The conductive polymer material is attached uniformly on the surface of the rod by a spray coating method and then baked at 80˜85° C. for approximately 20 seconds until the transparent conductive film with the conductive polymer material is uniformly attached onto the external surface of the rod.

4. The conductive polymer material is attached uniformly on the surface of the rod by a spray coating method and then baked at 50˜60° C. for approximately one minute until the transparent conductive film with the conductive polymer material is uniformly attached onto the external surface of the rod.

The touch portion 12 is disposed at an end of the transparent. hand holding portion 11, and the touch portion 12 has a flexible conductive element 121 which is made of a conductive rubber, conductive plastic, conductive foam or conductive fabric material and contacted with the capacitive panel, and the flexible conductive element 121 is electrically coupled to the transparent conductive film 112.

In a preferred embodiment as shown in the figure, a circular recession 113 is concavely formed at a position proximate to an end of the rod 111, and a corresponding snap portion 122 is formed at the flexible conductive element 121, and the snap portion 122. is snapped and secured into the circular recession 113, so that the flexible conductive element 121 can be fixed to an end of the rod 111 and contacted with the transparent conductive film 112 to form an electric connection. Of course, a ring 13 can be further installed and sheathed on the snap portion 122, wherein the ring 13 has an internal thread 131, and the rod 111 has a corresponding external thread 114 formed at an end of the rod 111, and both internal and external threads 131, 114 are screwed and engaged with each other to fix the ring 13 to the end of the rod 111 to cover the snap portion 122 and the circular recession 113 in order to prevent dusts or contaminants from being accumulated.

When use, a user holds the hand holding portion 11 of the touch structure 1 to touch the capacitive panel by a hand, and the user's body forms a conductive circuit by touching the sensing structure by the hand, and contacting an end of the flexible conductive element 121 with the capacitive panel, so that a capacitive coupling is produced in an electric field at an external conductive layer of the capacitive panel, and then the user's body absorbs a small current, so that a current can be measured at electrodes, and a touch operation can be achieved.

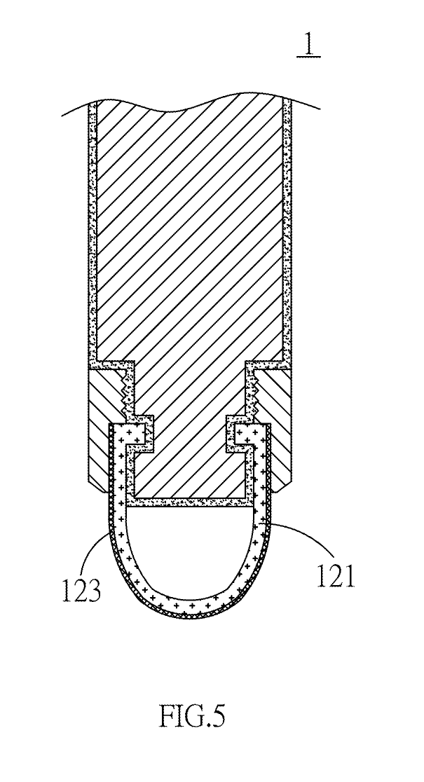

Further, a cladding layer 123 is formed on the flexible conductive element 121 as shown in FIG. 5 for providing a smoother surface for users to slide and touch the touch panel without pressing or damaging the touch panel, wherein the cladding layer 123 is formed on the flexible conductive element 121 by coating a carbon powder or a copper powder or the cladding layer 123 is made of a polyurethane (PU) material.

In addition, the transparent conductive film of the transparent hand holding portion is further covered by a protective layer for protecting the transparent conductive film, wherein the protective layer is made of an insulating material.

While the invention has been described by means of specific embodiments, numerous modifications and variations could be made thereto by those skilled in the art without departing from the scope and spirit of the invention set forth in the claims.

I claim:

1. A capacitive touch structure, comprising:
a transparent hand holding portion, provided for a user to hold, and including a rod and a transparent conductive film covered onto an external surface of the rod;
a touch portion, disposed at an end of the transparent hand holding portion, and having a flexible conductive element, and electrically coupled to the transparent conductive film.

2. The capacitive touch structure of claim 1, wherein the rod includes a circular recession concavely formed at a position proximate to an end of the rod, and the flexible conductive element includes a corresponding snap portion for snapping and securing into the circular recession.

3. The capacitive touch structure of claim 2, further comprising a ring sheathed and secured on the snap portion.

4. The capacitive touch structure of claim 3, wherein the ring includes an internal thread, and the rod has a corresponding external thread formed at a position proximate to an end of the rod.

5. The capacitive touch structure of claim 1, wherein the flexible conductive element includes a cladding layer formed thereon.

6. The capacitive touch structure of claim 5, wherein the cladding layer is formed on the flexible conductive element by coating carbon powder thereon.

7. The capacitive touch structure of claim 5, wherein the cladding layer is formed on the flexible conductive element by coating copper powder thereon.

8. The capacitive touch structure of claim 5, wherein the cladding layer is made of polyurethane (PU).

9. The capacitive touch structure of claim 1, wherein the flexible conductive element is made of a conductive rubber, a conductive plastic, a conductive foam or a conductive fabric.

10. The capacitive touch structure of claim 1, wherein the transparent conductive film is made of a conductive polymer material.

11. The capacitive touch structure of claim 1, wherein the rod is dipped into a liquid conductive polymer material for approximately 3 seconds, and then baked at 80˜85° C. for 20 seconds to form the transparent hand holding portion.

12. The capacitive touch structure of claim 1, wherein the rod is dipped into a liquid conductive polymer material for approximately 3 seconds, and then baked at 50˜60° C. for one minute to form the transparent hand. holding portion.

13. The capacitive touch structure of claim 1, wherein the conductive polymer material is uniformly attached onto a surface of the rod by using a spray coating method, and then baked at 80˜85° C. for 20 seconds to form the transparent hand holding portion.

14. The capacitive touch structure of claim 1, wherein a conductive polymer material is uniformly attached onto a surface of the rod by using a spray coating method, and then baked at 50˜60° C. for one minute to form the transparent hand holding portion.

15. The capacitive touch structure of claim 1, wherein the transparent conductive film of transparent hand holding portion further includes a protective layer covered thereon.

16. The capacitive touch structure of claim 15, wherein the protective layer is made of an insulating material.
